(19) United States
(12) Patent Application Publication
(10) Pub. No.: US 2025/0033975 A1
(43) Pub. Date: Jan. 30, 2025

(54) HIGH-EFFICIENCY, HIGH-YIELD ELECTROCHEMICAL EXFOLIATION PROCESS

(71) Applicants: Jonghyun Park, Rolla, MO (US); Tazdik Patwary Plateau, Rolla, MO (US)

(72) Inventors: Jonghyun Park, Rolla, MO (US); Tazdik Patwary Plateau, Rolla, MO (US)

(73) Assignee: The Curators of the University of Missouri, Columbia, MO (US)

(21) Appl. No.: 18/784,485

(22) Filed: Jul. 25, 2024

Related U.S. Application Data
(60) Provisional application No. 63/515,470, filed on Jul. 25, 2023.
(60) Provisional application No. 63/515,376, filed on Jul. 25, 2023.

(51) Int. Cl. C01B 32/19

(52) U.S. Cl. CPC C01B 32/19; C01P 2004/03

(57) ABSTRACT

Improved methods and systems for the electrochemical exfoliation of carbonaceous particles to provide graphene are provided. In some aspects, systems according to the present technology may include a plurality of electrodes that may, for example, have an aspect ratio greater than about 3:1. Additionally, a continuous and optionally closed-loop electrochemical exfoliation system may be used. Embodiments of the present technology can achieve graphene yields well in excess of 50% in a more cost- and operationally efficient manner.

### CROSS-REFERENCE TO RELATED APPLICATIONS

This application claims the priority benefit under 35 U.S.C. § 119(e) of U.S. Provisional Patent Application Ser. No. 63/515,470, entitled “High-Efficiency, High-Yield Electrochemical Exfoliation Process,” and U.S. Provisional Patent Application Ser. No. 63/515,376, entitled “Open-Structured Graphene from Select Biomass Sources and Methods of Making and Using the Same,” each filed on Jul. 25, 2023, the entire disclosures of which are incorporated herein by reference.

### BACKGROUND

### Field

This technology relates to the field of making and using graphene and, in particular, to improved exfoliation processes and systems for producing graphene with higher process efficiency and product yield.

### Description of Related Art

Graphene is a popular carbon material with high electrical conductivity and excellent mechanical properties. Numerous methods exist for producing graphene including mechanical processes, hydro-thermal processes, solvothermal processes, and oxidation derived processes. Graphite is the most common feedstock for each of these processes. Although graphite itself is generally inexpensive, each of these methods for producing graphene are complicated and, as a result, the graphene produced is also expensive. Thus, economical production of graphene on a commercial scale has been a persistent problem.

Because of its layered nature, exfoliation processes can also be used to produce graphene from graphite. There are several types of exfoliation processes including, for example, mechanical exfoliation, electrochemical exfoliation, chemical exfoliation, physical exfoliation, and thermomechanical exfoliation. Each of these exfoliation processes tends to involve complex and expensive synthesis procedures as well as time-consuming pre- and post-treatments, which further complicate their implementation on a commercial scale. Among them, electrochemical exfoliation typically has the highest yield rate and is, at least relatively, a simpler process.

During electrochemical exfoliation, electricity is used break the van der Waals bonds between adjacent graphite layers in order to produce graphene. Conventional electrochemical exfoliation systems utilize two electrodes, one of which is often formed from graphite. A voltage is applied across the electrodes to initiate an electrochemical reaction which splits off the outer carbon layers of the graphite to produce graphene. This process is limited by efficiency and yield rate of graphene, which is usually no more than about 38%.

Thus, a need exists for an improved, cost-effective method for efficiently producing graphene from graphite (or any other suitable carbon feedstock) that is simple and provides higher yields than can be achieved with other graphene production processes.

### SUMMARY

In one aspect, the present technology concerns a method for electrochemically exfoliating a plurality of carbonaceous particles to produce graphene, the method comprising: (a) combining the carbonaceous particles with a liquid to form a particle-containing dispersion; and (b) subjecting at least a portion of the particle-containing dispersion to electrochemical exfoliation to provide a plurality of graphene particles, wherein the subjecting includes at least one of the following (i) or (ii): (i) contacting the particle-containing dispersion with three or more electrodes, wherein the electrodes are spaced apart from one another each have an individual aspect ratio of at least about 6:1, wherein during the contacting at least a portion of the carbonaceous particles are contacted with at least one surface of at least one of the electrodes; (ii) passing at least a portion of the particle-containing dispersion through a reaction chamber comprising at least one electrode disposed therein, wherein during the passing at least a portion of the carbonaceous particles are contacted with at least one surface of the electrode.

In one aspect, the present technology concerns a reactor system for electrochemically exfoliating a plurality of carbonaceous particles to produce graphene, the system comprising: a reaction vessel defining an interior volume; three or more electrodes spaced apart from one another and each having an individual aspect ratio of at least about 6:1, wherein at least a portion of each of the electrodes is disposed within the interior volume of the reaction vessel and is positioned such that at least a portion of one or more of the electrodes is configured to be submerged in a particle-containing dispersion when the dispersion is present in the reaction vessel during operation; and a voltage source in electrical communication with and configured to apply a voltage across one or more of the electrodes.

In one aspect, the present technology concerns a continuous reactor for electrochemically exfoliating a plurality of carbonaceous particles to produce graphene, the system comprising: a reaction channel defining an interior passage; at least one electrode disposed in the interior passage of the reaction chamber; and a pump for passing the dispersion along a flow path in the system, wherein at least a portion of the flow path passes through the interior passage of the reaction chamber and in contact with at least a portion of a surface of the electrode.

### BRIEF DESCRIPTION OF THE DRAWINGS

Embodiments of the present invention are described herein with reference to the following drawing figures, wherein:

FIG. 1 is a schematic diagram of an electrochemical exfoliation system according to embodiments of the present technology, particularly illustrating a multiple electrode system;

FIG. 2 is a schematic diagram illustrating the main steps or zones of a continuous electrochemical exfoliation system according to embodiments of the present technology;

FIG. 3a is a schematic diagram of a continuous electrochemical exfoliation reaction step or zone according to embodiments of the present technology, particularly illustrating one embodiment of a reaction chamber;

FIG. 3b is a schematic diagram of a continuous electrochemical exfoliation reaction step or zone according to embodiments of the present technology, particularly illustrating another embodiment of a reaction chamber;

FIG. 4a is a graph summarizing the effect of varying electrolyte concentration during exfoliation of graphite on the electrical conductivity of the resulting graphene as described in the Example;

FIG. 4b is a graph summarizing the effect of varying exfoliation time of graphite on the electrical conductivity of the resulting graphene as described in the Example;

FIG. 5 is a three-dimensional graph summarizing the effect of exfoliation time and electrolyte concentration on the relative conductivity of graphene produced by electrochemical exfoliation of graphite as described in the Example;

FIG. 6a is a Scanning Electron Microscopy (SEM) image of the graphene formed by electrochemical exfoliation of the graphite shown in FIG. 6b according to the method described in the Example; and

FIG. 6b is an SEM image of the graphite used to form the graphene shown in FIG. 6a via the electrochemical exfoliation method described in the Example.

### DESCRIPTION

The present technology pertains to novel methods and systems for producing graphene from a carbonaceous feedstock, such as graphite.

As used herein, the term “graphene” refers to an at least partially ordered carbonaceous material that includes 10 or fewer monoatomic layers. In some embodiments, graphene can have a single layer, or it may be multi-layered. When multi-layered, graphene may include between about 2 and about 10, between about 2 and about 8, or between about 3 and about 6 layers. As used herein, the term “graphite” refers to a carbonaceous material having more than 10 monoatomic layers. In some cases, graphite can include more than about 15, more than about 20, or more than about 30 monoatomic layers. Typically, the bonding amongst carbon atoms within the layers of both graphene and graphite is sp² hybridized, while the inter-layer (between layers) bonding can be sp³ hybridized.

According to embodiments of the present technology, there are provided systems and methods for electrochemically exfoliating carbonaceous particles to produce graphene that utilizes enhanced carbon-electrode contact to increase process efficiency and yield. In some embodiments, the enhanced carbon-electrode contact may facilitate more and faster removal of free electrons generated during the exfoliation process to increase both the speed and overall production of graphene from the exfoliation process. For example, in some embodiments, the yield of graphene produced as described herein can be greater than about 40%, greater than about 45%, greater than about 50%, greater than about 55%, greater than about 60%, greater than about 65%, greater than about 75%, greater than about 80%, greater than about 85%, or greater than about 90%.

Carbonaceous feedstocks suitable for use in embodiments of the present technology can include any suitable type of multi-layered carbon material, often in the form of particles. In some embodiments, the carbonaceous feedstock can comprise a plurality of graphite particles, while, in other embodiments, the carbonaceous feedstock can comprise hard carbon particles. As used herein, the term “hard carbon” refers to a carbon material with a crosslinked structure of carbon, specifically non-graphitized carbon. It has both sp³ and sp² bonds in the carbon network and may be formed from different types of biomass materials. Additional details regarding hard carbon and the open-structured graphene produced via electrochemical exfoliation of hard carbon are provided in the co-pending application entitled “Open-Structured Graphene from Select Biomass Sources and Methods of Making and Using the Same,” which claims priority to U.S. Provisional Patent Application No. 63/515,376, the entirety of the co-pending application being incorporated herein by reference. In some embodiments, the carbonaceous feedstock can comprise at least about 75%, at least about 85%, at least about 90%, at least about 95%, at least about 99%, or about 100% by weight of graphite and/or hard carbon particles, based on the total weight of carbonaceous particles in the feedstock.

The carbonaceous particles (e.g., graphite and/or hard carbon particles) utilized in processes and systems as described herein can have an average particle size (D50) in the range of from about 2 microns to about 100 microns, about 5 microns to about 75 microns, about 10 microns to about 50 microns, about 5 microns to about 30 microns, about 10 microns to about 25 microns, about 15 microns to about 20 microns, about 10 microns to about 75 microns, about 15 microns to about 65 microns, or about 20 microns to about 50 microns. As used herein, the average particle size refers to the average largest surface-to-surface dimension of the particles. Unless otherwise noted herein, particle size was measured using a Dynamic Light Scattering Instrument (commercially available as Litesizer DLS 500 from Anton Parr) on a dispersion formed from 1 mg of particles in 10 mL of water mixed at 3500 rpm for 5 min.

In some embodiments, the carbonaceous feed particles can have a BET specific surface area in the range of from about 0.5 m²/g to about 10 m²/g, about 1 m²/g to about 8 m²/g, about 1.5 m²/g to about 7.5 m²/g, or about 1.75 m²/g to about 5 m²/g.

Prior to electrochemical exfoliation, the carbonaceous particles may be combined with at least one liquid to provide a carbonaceous particle dispersion. Examples of suitable liquids include water, alone or in combination with one or more organic solvents chosen from methanol, ethanol, isopropyl alcohol, dimethylformamide (DMF), or combinations thereof. In some embodiments, the liquid may consist essentially of, or consist of, water and at least one of the organic solvents, while, in other embodiments, the liquid may consist essentially of, or consist of, water or at least one of the organic solvents. In some embodiments, the carbonaceous particles may be present in the dispersion in an amount in the range of from about 0.1% to about 5% by weight, about 0.25% to about 3% by weight, or about 0.5% to about 2.5% by weight, based on the total weight of the dispersion taken as 100%.

In some embodiments, the carbonaceous particle dispersion may also include at least one electrolyte. The electrolyte can be chosen from sulfuric acid, ammonium hydroxides, tetra-n-butyl ammonium sulfate, potassium sulfate, sodium hydroxide, hydrogen peroxide, phosphoric acid, ammonium sulfate, sodium sulfate, potassium hydroxide, sodium bromide, sodium chloride, benzoic acid, sodium perchlorate, or combinations thereof. When used, the electrolyte may be present in the dispersion at a concentration of at least about 0.025 molar (M), at least about 0.05 M, at least about 0.10 M, at least about 0.15 M, or at least about 0.20 M and/or not more than about 7.5 M, not more than about 5 M, not more than about 4 M, not more than about 2.5 M, not more than about 1 M, not more than about 0.75 M, not more than about 0.5 M, not more than about 0.4 M, not more than about 0.25 M, or not more than about 0.2 M, or a concentration in the range of from about 0.025 M to about 5 M, about 0.10 M to about 4 M, or about 0.5 M to about 2.5 M.

The dispersion of carbonaceous particles can be formed by any method suitable for combining the particles and liquid to form a dilute dispersion. Thereafter, it may be introduced into an electrochemical exfoliation reaction zone or step, wherein the dispersion may contact at least a portion of one or more electrodes. The electrodes can be in electrical communication with at least one voltage source, which may apply a voltage across one or more of the electrodes and into the carbonaceous materials. Application of the voltage to the carbonaceous particles may result in breakage of the sp³ bonds (π bonds) between carbon layers, which causes disassociation of the outer layers of the carbon particle and forms graphene.

In some embodiments, the applied voltage can be at least about 1V, at least about 2V, at least about 3V, or at least about 5V and/or not more than about 25V, not more than about 20V, not more than about 15V, not more than about 12V, or not more than about 10V, or it can be in the range of from about 1V to about 25V, about 2V to about 20V, or about 5V to about 15V. The voltage may be applied for a time in the range of from about 1 hour to about 48 hours, about 8 hours to about 40 hours, about 10 hours to about 30 hours, or about 15 hours to about 25 hours. Several electrochemical exfoliation systems configured according to various embodiments of the present technology will now be discussed in detail below, with reference to the Figures.

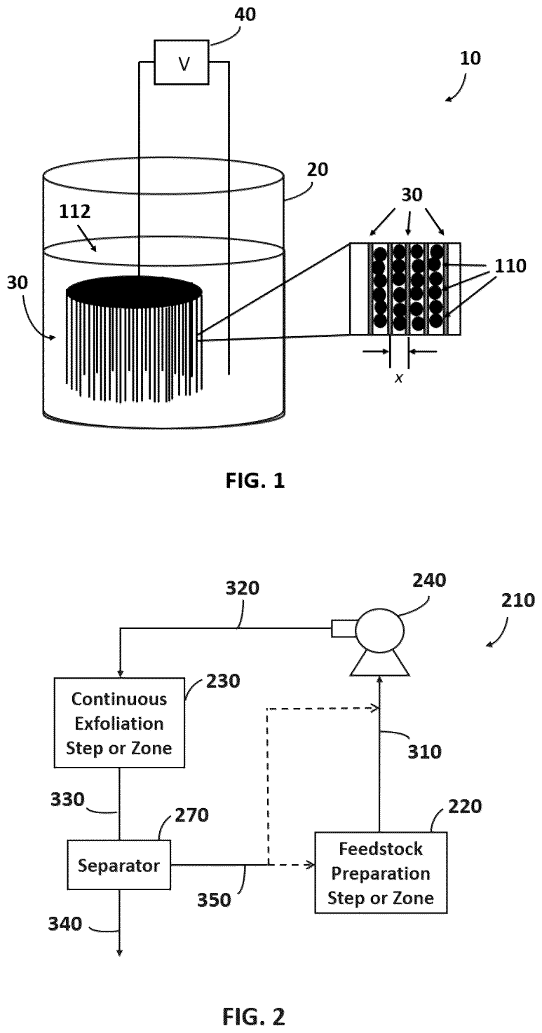

Turning now to FIG. 1, a schematic diagram of an electrochemical exfoliation reaction system 10 configured according to embodiments of the present technology is provided. In some embodiments, the system 10 shown in FIG. 1 can be operated in a batch or semi-batch manner. As shown in FIG. 1, the exfoliation reaction system 10 can include at least one reaction vessel (or container) 20 and a plurality of electrodes 30 disposed within an interior volume of the reaction vessel 20. Each of the electrodes 30 may be electrically connected to a voltage source 40, which, during operation, applies a voltage across one or more of the electrodes 30 during exfoliation of the carbonaceous particles 110 present in the reaction dispersion 112 within the reaction vessel 20.

In some embodiments of the present technology and as shown in FIG. 1, the electrochemical reaction system 10 can include a plurality of (e.g., more than two) electrodes 30. In some embodiments, the electrochemical reaction system 10 may include at least about 3, at least about 4, at least about 5, at least about 8, at least about 10, at least about 12, at least about 15, at least about 18, at least about 20, at least about 25, or at least about 30 individual electrodes and/or not more than about 200, not more than about 150, not more than about 100, not more than about 75, not more than about 50, not more than about 40, or not more than about 25 individual electrodes, or it can include from about 3 to about 100 individual electrodes, about 5 to about 75 individual electrodes, or about 20 to about 50 individual electrodes. In some embodiments, particularly commercial-scale embodiments, the electrochemical exfoliation processes and systems may include more than about 100, more than about 150, more than about 200, more than about 250, more than about 300, or even more than about 500 electrodes.

Each of the electrodes may comprise any suitable electrically conductive material and may, for example, comprise at least one metal chosen from platinum, gold, or combinations thereof, or it may be chosen from platinum-coated metals, gold-coated metals, or combinations thereof. According to some embodiments, none of the electrodes utilized in this reaction system may be carbon- or graphite-based electrodes. Thus, the electrodes utilized as described herein may include less than about 1, less than about 0.5, less than about 0.25, less than about 0.10, or less than about 0.05 weight percent graphite and other carbon-based materials, based on the total weight of all electrodes in the system.

Each of the electrodes can have any suitable shape and/or size, and in some embodiments, one or more electrodes can comprise a thin wire, as generally shown in FIG. 1. In such cases, each of the electrodes (or wires) can have an aspect ratio (i.e., ratio of length to diameter) of at least about 3:1, at least about 5:1, at least about 6:1, at least about 8:1, at least about 10:1, at least about 12:1, at least about 18:1, or at least about 20:1 and/or not more than about 200:1, not more than about 150:1, not more than about 100:1, not more than about 75:1, or not more than about 50:1, or it can be in the range of from about 5:1 to about 200:1, about 10:1 to about 100:1, or about 20:1 to about 50:1. In other embodiments, the wire electrodes can have an aspect ratio greater than about 10:1, greater than about 25:1, greater than about 50:1, greater than about 75:1, or even greater than about 100:1, particularly in commercial-scale systems.

According to some embodiments, the total surface area of electrodes in the electrical exfoliation reaction system can be significantly higher than in conventional exfoliation systems. For example, in some cases, the total surface area of the electrodes present in the electrochemical exfoliation reaction system can be at least about 25 times, at least about 50 times, at least about 75 times, at least about 100 times, at least about 250 times, or at least about 500 times higher than the total surface area of a conventional exfoliation system with a similar reaction vessel capacity. As used herein, the term “similar reaction vessel capacity” means a capacity within about +/−5%.

The absolute surface area of the electrodes can be in any suitable range, depending on the specific reactor size and configuration. In some embodiments, the total (absolute) surface area of the electrodes present in the electrochemical exfoliation reaction system can be in the range of from about 50 mm² to about 100 m², about 75 mm² to about 50 m², or about 100 mm² to about 25 m². In some embodiments, the total (absolute) surface area of the electrodes present in the electrochemical exfoliation reaction system can be in the range of from about 50 m² to about 10,000 m², about 250 m² to about 5000 m², or about 500 m² to about 2500 m²

In some embodiments, the ratio of total electrode surface area per mass of carbonaceous particles in the carbonaceous dispersion present in the electrochemical exfoliation reaction vessel can be at least about 50 m²/g, at least about 75 m²/g, at least about 100 m²/g, or in the range of from about 50 m²/g to about 500 m²/g, about 75 m²/g to about 350 m²/g, or about 100 m²/g to about 250 m²/g. In contrast, most conventional systems have a ratio of total electrode surface area per mass of feedstock of less than about 30 m²/g.

Additionally, or in the alternative, the ratio of the total surface area of the carbonaceous particles being treated in the electrochemical exfoliation reaction system to the total surface area of electrodes can be less than about 0.5, less than about 0.1, less than about 0.075, less than about 0.05, less than about 0.01, less than about 0.001, or less than about 0.001. It should be noted that total surface area of the particles in the reaction system can be calculated by multiplying the BET specific surface area of the carbonaceous feed (in m²/g) by the total mass of the sample introduced into the electrochemical exfoliation reaction vessel (in g). This value, divided by the total surface area of the electrodes in the electrochemical exfoliation reaction vessel, provides the aforementioned ratio.

Referring again to FIG. 1, when the electrochemical exfoliation reaction system 20 includes a plurality of electrodes 30, the electrodes may be spaced apart from one another by at least an electrode-spacing distance, x, measured along lines perpendicular to the centerlines of adjacent electrodes. In some embodiments, the electrode-spacing distance can be in the range of from about 50 nm to about 25 microns, about 75 nm to about 20 microns, or about 100 nm to about 10 microns. In some cases, the electrode-spacing distance can be sized relative to the average particle size of the carbonaceous particles 110 introduced into the reaction vessel 20. For example, in some embodiments, the electrode-spacing distance can be from about 1% to about 50%, about 2% to about 50%, or about 5% to about 25% larger than the average particle size of the carbonaceous particles 110 introduced into the reaction vessel 20.

When multiple and/or high surface area electrodes are used in the electrochemical exfoliation system 20, the electrodes may be arranged such that at least portion of the carbonaceous particles being exfoliated are in contact with more than one (usually adjacent) electrode at a time, as generally illustrated in the magnified inset of FIG. 1. In some cases, a single carbonaceous particle may be in contact with at least two, at least three, or at least four electrodes simultaneously. As a result, each of the carbonaceous particles 110 has an average contact time with the surface of one or more electrodes in the range of from about 1 hour to about 48 hours, about 2 hours to about 35 hours, or about 5 hours to about 24 hours. The average contact time with the surface of one or more electrodes is the total amount of time, on average, that each particle spends with a portion of its surface in direct contact with the surface of at least one electrode.

Turning now to FIG. 2, a schematic diagram illustrating the main steps or zones of a continuous electrochemical exfoliation system 210 according to embodiments of the present technology is provided. The system illustrated in FIG. 2 includes a feedstock preparation step or zone 220 followed by a continuous exfoliation step or zone 230. In some embodiments, the system 210 shown in FIG. 2 may be a closed-loop system, such that the carbonaceous particle dispersion may circulate through the entire system multiple times before the graphene particles are recovered as a product stream.

As shown in FIG. 2, the continuous system 210 includes a feedstock preparation step or zone 220. The feedstock preparation step or zone 220 may include any processing step or steps and equipment suitable for preparing the carbonaceous particle dispersion as discussed previously. After its formation, as shown in FIG. 1, the carbonaceous particle stream in line 310 can be introduced into a pump 240 (or other pressurizing device) to increase its pressure. Due to the presence of particles in the stream in line 310, the pump 240 should be designed to handle solids-containing streams. In some embodiments, the stream in line 310 can have a total solids content in the range of from about 0.5% to about 5% by weight, about 0.75% to about 3.5% by weight, or about 1% to about 2.5% by weight, based on the total weight of the stream taken as 100%.

After being discharged from the pump 240, the pressurized carbonaceous particle dispersion in line 320 may be introduced into a continuous exfoliation reaction step or zone 230, as generally shown in FIG. 2. As discussed previously, in the continuous exfoliation reaction step or zone 230, the particles contact at least a portion of one or more electrodes, which have an applied voltage. The resulting electrochemical reaction within the carbonaceous particles disassociates the outer layer, thereby forming the graphene as discussed in detail previously.

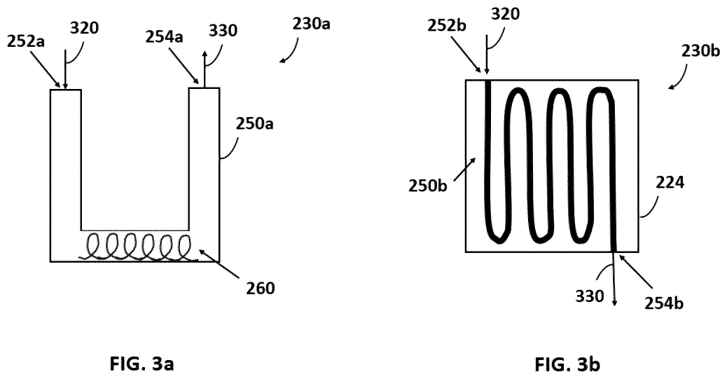

Turning now to FIGS. 3a and 3b, schematic diagrams of two exemplary configurations for the continuous exfoliation zone 230 illustrated in FIG. 2 are provided. Referring initially to FIG. 3a, one embodiment of a continuous exfoliation reaction zone 230a includes a reaction chamber (shown as channel 250a) having an inlet 252a for receiving carbonaceous particle feed in line 320 and an outlet 254a for discharging the reaction dispersion in line 330. Additionally, in some embodiments (not shown), the continuous exfoliation zone 230a can include multiple reaction channels, configured in parallel or in series, illustrated in FIG. 3a. The diameter (or width-wise dimension) of the reactor channel 250a, measured at its inner surface, can be in the range of from about 0.1 mm to about 10 mm, about 0.5 mm to about 7.5 mm, or about 1 mm to about 5 mm.

In some embodiments and as generally shown in FIG. 3a, at least one electrode 260 may be disposed in at least a portion of the reaction chamber 250a. The electrode 260 may have any of the properties or characteristics as described herein. Additionally, in some cases as shown in FIG. 3a, the electrode 260 may comprise a single coiled (e.g., spiral) electrode. Alternatively, in other embodiments (not shown), two or more electrodes could be located at the same or different locations with reaction chamber 250.

Referring now to FIG. 3b, the continuous exfoliation reaction zone 230b may include a reaction channel 250b that may be at least partially defined by a reactor support 224 (shown in FIG. 3b in cross-section). In some embodiments, the reaction channel 250b may be carved, etched, or otherwise cut from the reactor support 224 when the support 224 comprises, for example, a solid block of plastic or metal. In some embodiments, the reactor support 224 may comprise two complimentary parts (one of which is shown in FIG. 3b) each including half of the reaction channel 250b such that, when mated, the full reaction chamber is collectively defined by the two portions of the support.

Although shown as including a single reaction channel 250b, any suitable number of reaction channels can be formed in the reactor support 224. In some embodiments, each reactor support may comprise at least about 2, at least about 3, at least about 5, or at least about 10 reactor channels and/or not more than about 20, not more than about 15, not more than about 10, or not more than about 8 reactor channels. Additionally, although shown in FIG. 3b as being generally serpentine in shape, each reactor channel 250b in the reactor support 224 may have any suitable shape, including linear, non-linear, or combinations thereof. In some embodiments, the diameter (or width-wise dimension) of each reactor channel 250b, measured at its inner surface, can be in the range of from about 0.1 mm to about 3 mm, about 0.25 mm to about 2 mm, or about 0.5 mm to about 1.5 mm.

Further, although not shown in FIG. 3b, the reaction channel 250b may include at least one electrode (such as, for example, a wire electrode) inserted into at least a portion of the reaction channel 250b for contacting the carbonaceous feed stream as it passes through the channel 250b. Similarly to the exfoliation zone 230a shown in FIG. 3a, the reaction channel 250b shown in FIG. 3b may also include one or more than one electrode having any size, shape, and configuration and that is suitable for the specific shape and dimensions of the reaction channel 250b. The electrode can have any of the properties and dimensions as described herein.

Referring again to FIG. 2, a reactor outlet stream 330, which includes both graphene particles and residual carbonaceous particles that were not converted to graphene, may be withdrawn from the continuous exfoliation step or zone 230. In some embodiments, the reactor outlet stream in line 330 may be continually circulated through the system 210 by passing through a separator 270, wherein at least a portion of the solid components (graphene and/or graphite) can be removed via line 340 and the liquid portion may optionally be recirculated back to the feedstock preparation zone 220 via line 350, before being reintroduced into the inlet of pump 240. Thereafter, the pressurized stream can be again reintroduced into the inlet of the continuous exfoliation step or zone 230, wherein the particles can again be subjected to electrochemical exfoliation. The resulting outlet stream 330, which comprises more graphene and less residual carbonaceous particles, can again be recirculated through the system 210. In some embodiments, the reactor outlet stream 330 may be circulated throughout the system 210 for a total reaction time of about 1 hour to about 60 hours, about 2 hours to about 50 hours, about 5 hours to about 40 hours, about 10 hours to about 35 hours, or about 15 hours to about 25 hours. The specific velocity, flow rate, and single-pass residence time and conversion of the reactor outlet stream 330 through the exfoliation step or zone 230 depends, at least in part, on the reactor size, design, and specific system configuration.

As discussed above, the reactor outlet stream 330 may be passed through a separator 270, which may be configured to separate the particles in the reactor outlet stream 330 from the liquid component of the stream. In some embodiments, the separator 270 may also be configured to separate at least a portion of the graphene from any residual carbonaceous particles as well as from the liquid in the dispersion. As shown in FIG. 2, the liquid remaining after the particles of graphene and, optionally, residual carbonaceous particles are separated from the reactor outlet stream 330 may be returned to the feedstock preparation step or zone 220 and/or to the inlet of the pump 240 via line 350 for further recirculation through the system 210.

Any suitable method or equipment for separating the particles (graphene and/or any residual carbonaceous particles) from the liquid can be used. In some embodiments, at least a portion of the separation can be carried out within the continuous exfoliation step or zone 230. For example, in some cases, at least a portion of the outer surface of the reaction channel (e.g., reaction channels 250a and 250b, shown in FIGS. 3a and 3b) may include a plurality of small holes and a separation material may be wrapped around the holes. The separation material may be selected such that it permits transfer of the ionic liquid out of the reaction channel, but the pores may be sized such that the graphene (and any residual carbonaceous) particles are retained within the channel. For example, in some embodiments, the separator material can comprise a plurality of pores having an average pore size of about 15 microns to about 45 microns, about 20 microns to about 35 microns, or about 22 microns to about 30 microns.

Examples of a suitable separator material, when used, include, but are not limited to, polyolefins such as polyethylene and/or polypropylene. In some cases, the separator material can comprise multiple layer polymer sheets including, for example, alternating layers of polypropylene (PP) and polyethylene (PE). One example is a three-layer sheet having a PP/PE/PP configuration, or a sheet having a PE/PP/PE configuration.

The graphene-containing product stream in line 340 may comprise graphene in an amount in the range of from about 50% to about 99% by weight, about 60% to about 97% by weight, or about 80% to about 95% by weight, based on the total weight of particles (solids) in stream 340 taken as 100%. Additionally, or in the alternative, the reactor outlet stream 340 may comprise at least some residual graphite (or any other carbonaceous particle used as the feedstock) in an amount in the range of from about 1% to about 50% by weight, about 3% to about 40%, or about 5% to about 20%, based on the total weight of particles (solids) in reactor outlet stream 340 taken as 100%.

In other embodiments, the graphene product stream 340 recovered from the reaction system 210 can have purity of at least about 90% by weight, at least about 92% by weight, at least about 95% by weight, at least about 97% by weight, at least about 98% by weight, at least about 99% by weight, or at least about 99.5% by weight graphene, based on the total weight of the product recovered as 100%. In some embodiments, the graphene may comprise less than about 3% by weight, less than about 1% by weight, or about 0% by weight oxygen atoms and/or less than about 3% by weight, less than about 1% by weight, or about 0% by weight total atoms other than carbon atoms.

In some embodiments, the graphene product stream in line 340 may comprise less than about 10% by weight, less than about 8% by weight, less than about 95% by weight, less than about 3% by weight, less than about 2% by weight, less than about 1% by weight, less than about 0.5% by weight, or about 0% by weight of any solid particles or components except for graphene. For example, in some embodiments, the amount of graphite and other carbon-based solid particles or compounds may be present in an amount of less than about 10% by weight, less than about 8% by weight, less than about 95% by weight, less than about 3% by weight, less than about 2% by weight, less than about 1% by weight, less than about 0.5% by weight, or about 0% by weight, with the balance of the particles or compounds being graphene.

Regardless of the specific configuration of the electrochemical exfoliation system used, the graphene produced can have an average particle size (D50) smaller than the average particle size of the graphite (or other carbonaceous particle) used to produce it. For example, in some embodiments, the graphene may have an average particle size in the range of about 10 nm to about 2 microns, about 15 nm to about 1 micron, or about 25 nm to about 0.5 microns, which can be about 1.5 to about 20 times, about 2 to about 15 times, or about 5 to about 12 times smaller than the average particle size of the carbonaceous particles used to produce it.

In some embodiments, the electrical conductivity of the graphene can be higher than the electrical conductivity of the carbonaceous particles used to produce the graphene. For example, the electrical conductivity of the graphene product can be higher than the electrical conductivity of the carbonaceous particles used to form the graphene by about 5 to about 150 times, about 10 to about 125 times, about 20 to about 100 times, or about 50 to about 75 times.

In some embodiments, the electrical conductivity of the graphene product can be at least 300 Siemens/cm (S/cm), at least 350 S/cm, at least 400 S/cm and/or not more than about 600 S/cm, not more than about 550 S/cm, not more than 500 S/cm, or not more than 475 S/cm, or it can be in the range of from about 300 S/cm to about 750 S/cm, about 350 S/cm to about 600 S/cm, or about 400 S/cm to about 550 S/cm, while the carbonaceous particles used to form the graphene product can have an electrical conductivity of at least about 6.5 S/cm, at least about 7 S/cm, at least about 7.5 S/cm, at least about 8 S/cm, or at least about 8.25 S/cm and/or not more than 10 S/cm, not more than about 9.5 S/cm, not more than about 9 S/cm, not more than about 8.75 S/cm, or not more than about 8.5 S/cm, or it can be in the range of from about 6.5 S/cm to about 10 S/cm, about 7 to about 9.5 S/cm, or about 7.5 to about 9 S/cm. The electrical conductivity of the materials described herein was measured using a four-point probe measurement technique with a digital source meter (Keithley 2400).

### Example

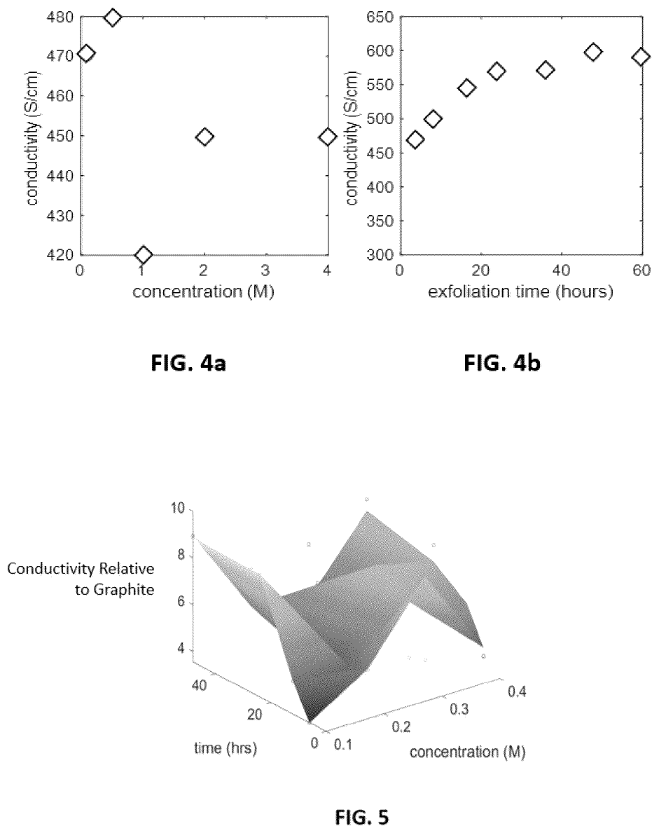

Several graphite dispersions were formed by adding 2 grams of graphite (commercially available from Sigma Aldrich) to electrolyte solutions of ammonium sulfate in water at different concentrations ranging from 0.25 M to 4 M. In each case, the graphite, water, and ammonium sulfate were mixed together with a magnetic stirring rod at a speed of 400 rpm for 1 hour. Each dispersion was then subjected to electrochemical exfoliation in a system similar to that illustrated in FIG. 1 but utilizing 21 platinum wire electrodes which were soldered together. Several trials were run in which the individual dispersions were subjected to electrochemical exfoliation at an applied voltage of 10V for 24 hours. The electrical conductivity of the resulting graphene dispersion (which included both product graphene and any residual graphite) was measured for each concentration using the four-point probe measurements as described herein and the results are summarized in FIG. 4a. As shown in FIG. 4a, graphene products having higher conductivities were produced using lower (e.g., 0.25 M and 0.5 M) electrolyte concentrations.

A second set of graphite dispersions were formed, each including 2 grams of graphite (commercially available from Fisher Scientific) in a 0.5-M ammonium sulfate solution. A similar electrochemical exfoliation process was conducted using a batch system as shown in FIG. 1, but with 21 platinum-wire electrodes. The total exfoliation time was varied from 1 to 60 hours, and the electroconductivity of the resulting graphene dispersion (e.g., graphene and residual graphite) was tested. The results of these trials are summarized in FIG. 4b. As shown in FIG. 4a, the electrical conductivity of the product graphene increased for contact times of about 1 hour to about 24 hours, at which time the conductivity leveled off at about 575 S/cm.

Several additional trials were conducted using similar 2-gram graphite dispersions including ammonium sulfate, but with both the electrolyte concentration and reaction time being varied. The results of these trials are summarized in the 3-dimensional graph provided in FIG. 5. Note that the vertical axis in FIG. 5 is the relative conductivity of the product graphene dispersion as compared to the starting graphite dispersion. As shown in FIG. 5, use of a 0.1M electrolyte (ammonium sulfate) solution and an exfoliation time of 48 hours, a 9-fold increase in electrical conductivity can be achieved. For this trial, the electrical conductivity of the graphene dispersion was 760 S/cm.

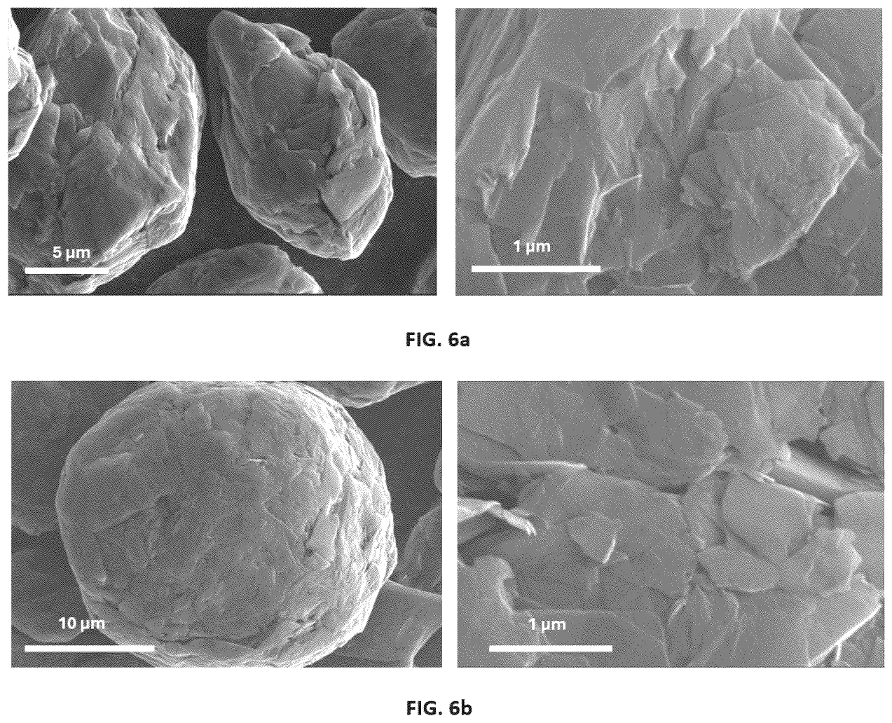

The impact of exfoliation on the graphite particles can be observed via Scanning Electron Microscopy (SEM) images, as shown in FIGS. 6a and 6b. The SEM images shown in FIGS. 6a and 6b were captured at 15,000× (left image) and 150,000× (right image) to provide views of both the particle (left image) and the surface of the particle (right image). The graphene shown in FIG. 6b was obtained from the graphite shown in FIG. 6a according to the process described above.

### Definitions

As used herein, the term “graphene” refers to an at least partially ordered carbonaceous material that includes 10 or less monoatomic layers. Graphene can have a single layer, or it can be multi-layered (e.g., 2 to 10 layers).

As used herein, the term “graphite” refers to a carbonaceous material having more than 10 layers. The bonding within the layer is generally sp² hybridized and between layers is generally sp³ hybridized.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

What is claimed is:

1. A method for electrochemically exfoliating a plurality of carbonaceous particles to produce graphene, the method comprising:
(a) combining the carbonaceous particles with a liquid to form a particle-containing dispersion; and
(b) subjecting at least a portion of the particle-containing dispersion to electrochemical exfoliation to provide a plurality of graphene particles,
wherein the subjecting includes at least one of the following (i) or (ii):
(i) contacting at least a portion of the carbonaceous particles in the particle-containing dispersion with three or more electrodes spaced apart from one another and each having an individual aspect ratio of at least about 6:1;
(ii) passing at least a portion of the particle-containing dispersion through a reaction chamber and during at least a portion of the passing, contacting the carbonaceous particles with at least one electrode.

2. The method of claim 1, wherein the subjecting includes contacting at least a portion of the carbonaceous particles in the particle-containing dispersion with three or more electrodes spaced apart from one another and each having an individual aspect ratio of at least about 6:1.

3. The method of claim 2, wherein the three or more electrodes comprise at least 10 electrodes spaced apart from each other and wherein each of the electrodes comprises platinum or a platinum-coated metal.

4. The method of claim 2, wherein each of the three of more electrodes has an aspect ratio of at least about 20:1.

5. The method of claim 2, wherein during the contacting, at least a portion of the carbonaceous particles are contacted with a surface of at least two of the three or more electrodes simultaneously.

6. The method of claim 1, wherein the subjecting includes passing at least a portion of the particle-containing dispersion through the reaction chamber and during at least a portion of the passing, contacting the carbonaceous particles with at least one electrode.

7. The method of claim 6, wherein the passing is carried out in a continuous, closed-loop manner.

8. The method of claim 6, wherein the at least one electrode includes a single electrode having a coiled shape.

9. The method of claim 1, wherein ratio of the total surface area of the three or more electrodes in (i) and/or of the at least one electrode in (ii) mass of carbonaceous particles in the particle-containing dispersion is in the range of from about 50 m²/g to about 500 m²/g.

10. The method of claim 1, wherein the subjecting includes applying a voltage across the three or more electrodes in (i) and/or the at least one electrode in (ii), wherein the voltage is in the range of about 2V to about 20V and wherein the subjecting is carried out for a time period of about 10 hours to about 30 hours.

11. The method of claim 1, wherein the particle-containing dispersion further comprises at least one electrolyte present in the particle-containing dispersion in an amount in the range of from about 0.5 M to about 2.5 M.

12. The method of claim 1, wherein the subjecting is carried out to provide a total graphene yield of at least about 75%.

13. A system for electrochemically exfoliating a plurality of carbonaceous particles to produce graphene, the system comprising:
a reaction vessel defining an interior volume;
three or more electrodes spaced apart from one another and each having an individual aspect ratio of at least about 6:1, wherein at least a portion of each of the electrodes is disposed within the interior volume of the reaction vessel and is positioned such that at least a portion of one or more of the electrodes is configured to be submerged in a particle-containing dispersion when the dispersion is present in the container during operation; and
a voltage source in electrical communication with and configured to apply a voltage across one or more of the electrodes.

14. The system of claim 13, wherein the individual aspect ratio of each of the three or more electrodes is at least about 20:1.

15. The system of claim 13, wherein the three or more electrodes comprises at least about 20 and not more than about 50 electrodes.

16. The system of claim 13, wherein each of the three or more electrodes comprises platinum or a platinum-coated metal.

17. The system of claim 13, wherein the three or more electrodes are spaced apart from adjacent ones by an electrode-spacing distance in the range of from about 50 nm to about 25 microns.

18. A continuous system for electrochemically exfoliating a plurality of carbonaceous particles to produce graphene, the system comprising:
a reaction channel defining an interior passage;
at least one electrode disposed in the interior passage of the reaction chamber; and
a pump for passing the dispersion along a flow path in the system, wherein at least a portion of the flow path passes through the interior passage of the reaction chamber and in contact with at least a portion of a surface of the electrode.

19. The system of claim 18, wherein the at least one electrode comprises a single coiled electrode disposed within a portion of the interior volume of the reaction chamber.

20. The system of claim 18, further comprising a separator for separating the dispersion withdrawn from the reaction channel into a liquid portion and a graphene-containing portion, and wherein the separator is configured to return at least a portion of the liquid portion to an inlet of the pump.
